(19) United States
(12) Patent Application Publication
(10) Pub. No.: US 2003/0084257 A1
(43) Pub. Date: May 1, 2003

(54) Flash emulator

(76) Inventors: Keith R. Mowery, Plano, TX (US); William F. Harris, Dallas, TX (US); Daniel G. Jensen, Plano, TX (US)

Correspondence Address: TEXAS INSTRUMENTS INCORPORATED, P O BOX 655474, M/S 3999, DALLAS, TX, 75265

(21) Appl. No.: 10/261,811

(22) Filed: Oct. 1, 2002

Related U.S. Application Data
(60) Provisional application No. 60/335,693, filed on Oct. 30, 2001.

(51) Int. Cl. G06F 12/00

(52) U.S. Cl. 711/154; 711/100

(57) ABSTRACT

A method and apparatus for the loading of a control program of a peripheral (for example, peripheral 325) via a communications link between a computer (for example, computer 305) and the peripheral 305. The control program is stored in a first memory (for example, memory 315) and upon system power-up or reset, a driver program reads the control program and loads the control program into a second memory (for example, RAM 335) located in the peripheral 325. The need for a custom memory interface and flash memory in the peripheral 325 is eliminated.

This application claims priority to a provisional application entitled “Wireless PCI Single Chip Solution,” serial No. 60/335,693, filed Oct. 30, 2001. The provisional application is incorporated herein by reference.

### FIELD OF THE INVENTION

This invention relates generally to digital devices and particularly to digital circuitry requiring the downloading of control software for proper operation.

### BACKGROUND OF THE INVENTION

Many of today's electronic devices, especially devices that connect to a computer, are controlled by a processing element (or a micro-controller), such as a digital signal processor or a generic general purpose micro-processor. Devices that are attached to or built into a computer are normally referred to as peripherals. It is this processing element that gives these electronics and peripherals “smarts”. Prior to the inclusion of a processing element in electronics, the peripherals where fairly simple or had hard-wired control logic. The hard-wired control logic also tended to be simple as well, due to the complexity of designing such logic.

The use of a processing element has permitted the creation of peripherals that can provide unprecedented of flexibility and functionality. The processing element executes control software that contains software routines which are used to control the various hardware components of the peripherals. The control software is normally stored in a memory and is loaded into the processing element at system power-up or reset. The memory used to store the control software needs to be able to retain the control software even when there is no power being applied to the peripheral. Therefore, the memory is normally a read-only memory (ROM), a flash programmable ROM, an electrically programmable ROM (EPROM), an electrically erasable programmable ROM (EEPROM), flash random access memory (RAM), or one of many other types of memory that is capable of retaining their contents without power. These programmable memory chips are commonly collectively referred to as flash memory chips.

Upon system power-up or reset, the control program is loaded into the processing element from the memory. The processing element's access to the memory is normally through a custom memory interface, complete with control, address, and data lines. For example, with a 16-bit data bus, the custom memory interface would require 20 or more input/output (I/O) pins on the processing element. The addition of these I/O pins can greatly increase both the size and the cost of the packaging of the processing element, thereby contributing to increasing the cost of the device.

Additionally, the use of programmable memory makes it more difficult to upgrade the control software. Typically, a special program is executed that overwrites the contents of the memory with the new control program. If an error were to occur during the writing process, then it is possible that the device would be rendered inoperable. Additionally, if ROMs are used to store the control software, then it is impossible to upgrade the control software without physically replacing the ROM chip.

A need has therefore arisen for a method and apparatus to permit the storage of control software for use in a peripheral that does not increase the overall cost of the peripheral and allows for easy upgrades to the control software.

### SUMMARY OF THE INVENTION

In one aspect, the present invention provides a method for loading a control program into an integrated circuit attached to a computer, wherein the integrated circuit contains an internal memory, the method comprising the steps of reading the control program from a first memory, wherein the first memory is located in the computer, transferring the control program to the integrated circuit via a communications bus on the computer, the communications bus used to attach the integrated circuit to the computer, and storing the control program in the internal memory.

In another aspect, the present invention provides an integrated circuit comprising a communications bus coupled to a computer, the communications bus to provide a communications conduit between the integrated circuit and the computer, a processing element coupled to the communications bus, the processing element comprising a memory coupled to the communications bus, the memory to store programs and data and the memory is loaded with a control program-from a memory in the computer each time the integrated circuit is initialized, and the integrated circuit further comprising a processing unit coupled to the memory and the communications bus, the processing unit to execute programs stored in the memory.

In yet another aspect, the present invention provides a computer system comprising a processor, a first memory coupled to the processor, the first memory to store programs and data, a communications bus coupled to the processor, the communications bus provides a communications conduit for the processor, an integrated circuit coupled to the communications bus, the integrated circuit to add additional functionality to the computer, the integrated circuit comprising a processing element coupled to the communications bus, the processing element comprising a second memory coupled to the communications bus, the memory to store programs and data and the second memory is loaded with a control program from the first memory located in the computer each time the computer is initialized, and a processing unit coupled to the second memory and the communications bus, the processing unit to execute programs stored in the second memory.

In a further aspect, the present invention provides a method for upgrading a control software program in an integrated circuit comprising the steps of storing an upgraded control software program on a first memory, the first memory located in a computer, initializing the computer, reading the upgraded control software program from the first memory, transferring the upgraded control software program to the integrated circuit via a communications bus on the computer used to attach the integrated circuit to communicate to the computer, and storing the upgraded control software program in a second memory, located in the integrated circuit.

The present invention provides a number of advantages. For example, use of a preferred embodiment of the present invention permits the quick, easy, and safe upgrade of the software needed to control the operation of a peripheral. Since no modifications are required to a flash memory chip (nor is one present), it is not possible to damage the control software that is typically stored in a flash memory chip, which would render the peripheral unusable. The upgrade process is also made simpler due to the elimination of the upgrading of the flash memory step.

Also, use of a preferred embodiment of the present invention allows storage and loading of control software for peripherals that are coupled to a computer to be loaded via an existing connection to the computer, rather than requiring a custom and dedicated memory interface that increases complexity and costs.

### BRIEF DESCRIPTION OF THE DRAWINGS

The above features of the present invention will be more clearly understood from consideration of the following descriptions in connection with accompanying drawings in which:

FIG. 1 illustrates a computer and a peripheral attached to each other via a cable;

FIG. 2 illustrates a functional view of a computer with an attached peripheral wherein the peripheral has a flash memory chip for storing its control program; and

FIG. 3 illustrates a functional view of a computer with an attached peripheral wherein a control program is provided to a processing element of the peripheral via the computer according to a preferred embodiment of the present invention.

### DETAILED DESCRIPTION OF ILLUSTRATIVE EMBODIMENTS

The making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the invention.

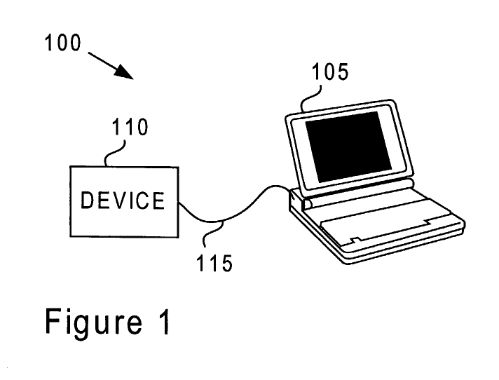

Referring now to FIG. 1, the diagram illustrates a computer (PC) 105 and a peripheral 110 attached to each other via a cable 115. Depending on the functionality of the peripheral 110, the peripheral 110 may be referred to as a device, when its function is relatively simple. For example, an example of a device would be a circuit that monitors the weather that is attached to a computer. Alternatively, a peripheral may be integrated into an integrated circuit, wherein all needed functionality is contained within the integrated circuit.

Although displayed as being attached to the PC 105 by a cable, the peripheral 110 may be contained inside a slot in the PC 105 and may be directly coupled to the PC 105 via a port, such as through a laptop PC's PCCard slot or some proprietary port. The diagram illustrates how devices can be attached to a PC to enhance the PC's functionality and usability. The peripheral 110 being attached to the PC 105 may be one of a wide variety of devices, including but not limited to keyboards (wireless and wired), modems, network adapters, multimedia devices, security devices, storage devices, etc.

Unless they are very simple, peripherals that connect to a computer typically have a processing element of their own. The processing element is used to control the operation of the peripheral. By having the processing element inside the peripheral control the operation of the peripheral rather than having the computer control the operation of the peripheral, the computational overhead that would be placed onto the computer can be greatly reduced. This results in improved performance for both the computer and the peripheral. The processing element needs to execute computer code in order to control the peripheral. This code is typically stored in a flash memory device located inside the peripheral.

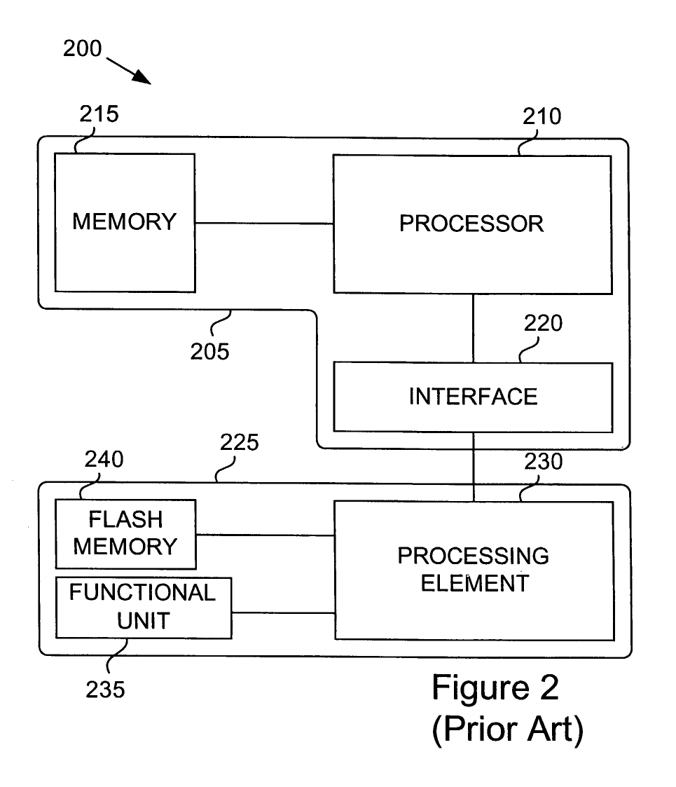

Referring now to FIG. 2, the functional block diagram illustrates a computer (PC) 205 with an attached peripheral 225. The peripheral 225 typically includes a processing element (either a micro-controller or a microprocessor) that is appropriately sized (in terms of processing power) for the processing requirements of the peripheral 225. The processing element executes a program that allows it to control the operation of the peripheral 225. Notice that although FIG. 2 displays the peripheral 225 as a separate device and is attached to the PC 205, giving the impression that the device 225 is external to the PC 205, the device 225 may be an integrated circuit that is located inside the computer housing of the PC 205 or it may be on a circuit board that is located inside the computer housing of the PC 205 and is connected to the motherboard of the PC 205.

The device 205 includes a processing element 230 that is coupled to a functional unit 235 and a flash memory device 240. The flash memory device 240 is responsible for storing the program that executes on the processing element 230, which in turn controls the operation of the functional unit 235. The processing element 230 interfaces with the flash memory device 240 via a special memory interface (not shown) that normally includes several data pins (equal in number to the width of a memory word size, typically eight or 16 bits), several address pins (depending on the number of memory words in the flash memory device), and several control pins. Therefore, it is easy to see that the number of I/O pins in the flash memory interface being equal to or greater than 10 to 20 pins.

The device 225 and the processing element 230 are also coupled to the PC 205 via a communications bus, such as a USB, IEEE 1394, or some proprietary interface. The communications bus permits the peripheral 225 and the PC 205 to exchange data and information. The PC 205 includes a processor 210 and a memory 215 of its own. The memory 215, though displayed as a single block of memory, may actual represent a multi-layered memory space, such as a multi-layered memory with a high-speed cache, random access memory (RAM), flash memory, and low-speed secondary memory such as a disk drive or compact disc. Alternatively, the memory 215 may represent solid-state memory and the PC 205 would have a form of magnetic (disk or tape based) memory (not shown) that functions as secondary storage.

Each time that the peripheral 225 is powered-up or after a reset, the micro-controller 230 accesses the flash memory device 240 to load the program and begin execution. Depending on how it is designed, the processing element 230 loads only as much of the program as it needs to execute or as much as it can hold. When the processing element 230 needs more of the program, it simply loads more from the flash memory device 240. Alternatively, the processing element 230 may load the entire program prior to execution.

Although the use of a flash memory device to store the program for controlling the peripheral 225 provides a good solution to the problem of providing storage for the program, the flash memory interface requires a large number of I/O pins for data, address, and control. The large number of pins results in a larger physical size for the processing element 230, making it more difficult to minimize the size of the peripheral 225 (either as a stand-alone device or as an integrated circuit). The flash memory interface may be created as a serial interface to reduce the number of pins required, although a serial interface could severely restrict performance, due to its lower data transfer rate. Additionally, the use of the flash memory device 240 makes it more difficult to upgrade the program stored in the flash memory device. In order to upgrade the memory, a special flash update program must be executed. If an error occurs during the flash update, it is possible for the device to become inoperable due to damage to the control program stored in the flash memory device 240.

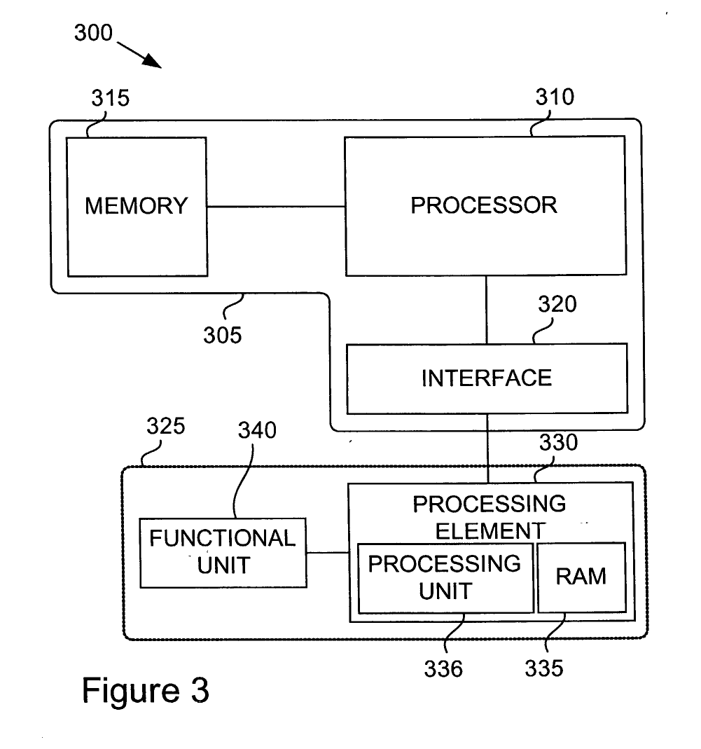

Referring now to FIG. 3, the functional block diagram illustrates a PC 305 with a peripheral 325 attached, the peripheral 325 featuring a memory-based program loading mechanism according to a preferred embodiment of the present invention. According to a preferred embodiment of the present invention, the peripheral 325 includes a processing element 330 with a RAM block 335 that is sufficiently large to store the program that controls the peripheral 325. The processing element 330 also includes a processing unit 336, wherein the processing unit 336 is responsible for the execution of the control program. The peripheral 325 also includes a functional unit 340. Note that the peripheral 325 may be integrated into a single integrated circuit containing both the processing element 330 and the functional unit 340 on a semiconductor die.

Notice the lack of a flash memory device like the flash memory device 240 present in the peripheral 225 (FIG. 2). According to a preferred embodiment of the present invention, rather than storing the program in a flash memory device and then subsequently loading the program from a flash memory device as the program is executed, the program is loaded into the RAM 335 during system power-up by the PC 305. Once the program is loaded into the RAM 335, the program is executed directly from the RAM 335. According to a preferred embodiment of the present invention, the entire program is loaded into the RAM 335.

Since the program is being stored in the RAM 335, power needs to be maintained to preserve the contents of the RAM 335, and upon power-up (or reset or re-initialization), the program needs to be loaded into the RAM 335. When the system (both the PC 305 and the peripheral 325) is being powered-up, a driver (not shown) that is installed on the PC 305 reads the program from a memory 315 and delivers it to the peripheral 325 via a connection between the PC 305 and the peripheral 325. Alternatively, there are several other instances in addition to system power-up (or reset or re-initialization) when the program needs to be loaded into the RAM 335. For example, when the PC 305 is placed into a hibernate mode (where the contents of the PC's memory is stored in non-volatile memory and the PC 305 can be rapidly restored to its normal operating mode) or a suspend mode (where the PC 305 is placed in a low power mode and unneeded hardware is powered down), then when the PC 305 is restored, the driver (not shown) will read the program from the memory 315 and deliver it to the peripheral.

As discussed previously, a computer's memory may actually represent several different storage types. For example, a computer will typically have some solid-state memory (a high-speed cache, ROM, RAM, etc.), some magnetic, disk-based memory (hard-disk drives, floppy-disk drives, etc.), and some removable memory (cd-rom, flash memory cards, etc.). All of these different types of memory can be represented as a single memory block, for example, the memory 315. According to a preferred embodiment of the present invention, the program is stored on magnetic disk-based memory, such as a hard-disk (not shown) on the PC 305. Alternatively the program may be stored on a floppy disk, compact disk, solid-state memory or any other form of memory storage for the PC 305.

According to a preferred embodiment of the present invention, the program is loaded onto the peripheral 325 via an existing connection between the peripheral 325 and the PC 305, such as via a USB, IEEE 1394, or some proprietary connection. Therefore, no additional interface is needed to load the program, resulting in a reduction in the hardware requirements for the peripheral 325. The program loading may be initiated by a driver program (not shown) that is part of the PC's operating system and configured so that the driver program executes each time that the PC 305 is powered on, initialized, or reset. When the driver program is executed, it takes the program (stored in the PC's memory 315) and loads the program into the RAM 335 of the peripheral 325.

Additionally, since the program is stored in the memory 315 of the PC 305, upgrading the program is easily accomplished by copying a file from some distribution media or method (email, floppy disk, cd-rom, memory card, etc.) to the place where the program is to be stored in the memory 315. Then, to finish the upgrade, the computer 305 is re-started (or reset) and the new program is loaded onto the peripheral 325 by the driver program. Actually, the loading of the upgraded program can be transparent to the driver program, since it does not need to know if the program it is loading into the peripheral 325 is an upgraded program. According to another preferred embodiment of the present invention, the program may be explicitly loaded onto the peripheral 325 by the issuance of a special command, so that the PC 305 does not need to be re-started (or reset).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for loading a control program into an integrated circuit attached to a computer, wherein the integrated circuit contains an internal memory, the method comprising:
reading the control program from a first memory, wherein the first memory is located in the computer;
transferring the control program to the integrated circuit via a communications bus on the computer, the communications bus used to attach the integrated circuit to the computer; and
storing the control program in the internal memory.

2. The method of claim 1, wherein the integrated circuit contains a peripheral integrated into the integrated circuit.

3. The method of claim 1, wherein the control program is read in its entirety from the first memory and stored in the internal memory.

4. The method of claim 1, wherein the first memory is a disk-based storage device.

5. The method of claim 1, wherein the internal memory is located inside the integrated circuit.

6. The method of claim 5, wherein the internal memory is a random access memory.

7. The method of claim 1, wherein the method is initiated upon the initialization of the computer.

8. The method of claim 1, wherein the method is initiated upon the reset of the computer.

9. The method of claim 1, wherein the method is initiated by a command issued by the computer.

10. The method of claim 1, wherein the method is initiated upon the computer coming out of hibernation mode.

11. The method of claim 1, wherein the method is initiated upon the computer coming out of stand-by mode.

12. An integrated circuit comprising:
a communications bus coupled to a computer, the communications bus to provide a communications conduit between the integrated circuit and the computer;
a processing element coupled to the communications bus, the processing element comprising:
a memory coupled to the communications bus, the memory to store programs and data and the memory is loaded with a control program from a memory in the computer each time the integrated circuit is initialized; and
a processing unit coupled to the memory and the communications bus, the processing unit to execute programs stored in the memory.

13. The integrated circuit of claim 12, wherein the integrated circuit contains a peripheral integrated into the integrated circuit.

14. The integrated circuit of claim 12, wherein the memory is a random access memory and is sufficiently sized to contain the control program in its entirety.

15. The integrated circuit of claim 12, wherein the control program is loaded from the computer via the communications bus.

16. The integrated circuit of claim 12, wherein the control program is loaded each time the computer is initialized.

17. The integrated circuit of claim 12, wherein the control program is loaded each time the computer is reset.

18. The integrated circuit of claim 12, wherein the control program is loaded as the result of the execution of a command by the computer.

19. A computer system comprising:
a processor;
a first memory coupled to the processor, the first memory to store programs and data;
a communications bus coupled to the processor, the communications bus provides a communications conduit for the processor;
an integrated circuit coupled to the communications bus, the integrated circuit to add additional functionality to the computer, the integrated circuit comprising:
a processing element coupled to the communications bus, the processing element comprising:
a second memory coupled to the communications bus, the memory to store programs and data and the second memory is loaded with a control program from the first memory located in the computer each time the computer is initialized; and
a processing unit coupled to the second memory and the communications bus, the processing unit to execute programs stored in the second memory.

20. The computer system of claim 19, wherein the computer further comprising a driver program stored in the first memory, the driver program loads the control program onto the peripheral each time the driver program is executed.

21. The computer system of claim 20, wherein the driver program is executed each time the computer system is powered on.

22. The computer system of claim 20, wherein the driver program is executed each time the computer system is reset.

23. The computer system of claim 20, wherein the driver program is executed each time a specific command is issued.

24. The computer system of claim 20, wherein the driver program is executed each time the computer system is brought out of hibernate mode.

25. The computer system of claim 20, wherein the driver program is executed each time the computer system is brought out of suspend mode.

26. A method for upgrading a control software program in an integrated circuit comprising:
storing an upgraded control software program on a first memory, the first memory located in a computer;
initializing the computer;
reading the upgraded control software program from the first memory;
transferring the upgraded control software program to the integrated circuit via a communications bus on the computer used to attach the integrated circuit to communicate to the computer; and
storing the upgraded control software program in a second memory, located in the integrated circuit.

27. The method of claim 26, wherein the storing step comprises copying the upgraded control software program from a distribution media onto the first memory.

28. The method of claim 26, wherein the initializing step comprises the issuance of a reset command.

29. The method of claim 26, wherein the initializing step comprises a reset of the computer.

30. The method of claim 29, wherein the initializing step comprises a reset of the computer and the peripheral.
